(19) United States
(12) Patent Application Publication
(10) Pub. No.: US 2024/0047814 A1
(43) Pub. Date: Feb. 8, 2024

(54) BATTERY MODULE HAVING A CELL SEPARATING ELEMENT AND METHOD FOR PRODUCING A BATTERY MODULE

(71) Applicant: AUDI AG, Ingolstadt (DE)

(72) Inventor: Sascha STAUDENMAIER, Hitzhofen (DE)

(73) Assignee: AUDI AG, Ingolstadt (DE)

(21) Appl. No.: 18/357,296

(22) Filed: Jul. 24, 2023

(30) Foreign Application Priority Data
Aug. 3, 2022 (DE) 102022119478.7

(51) Int. Cl. H01M 50/293; H01M 10/658; H01M 50/209; H01M 50/264

(52) U.S. Cl. CPC H01M 50/293; H01M 10/658; H01M 50/209; H01M 50/264

(57) ABSTRACT

A battery module with a cell stack which has a plurality of battery cells arranged next to one another in a stacking direction, the battery cells include a first and a second battery cell which are arranged adjacent to one another in the stacking direction. A cell separating element for electrical and thermal insulation of the first and second battery cells from one another is arranged at least between the first and second battery cells, and the cell separating element rests flat on the first and second battery cell. A frictional connection is present between the cell separating element and at least the first battery cell, which connection counteracts a relative movement of the at least one first battery cell and the cell separating element perpendicular to the stacking direction.

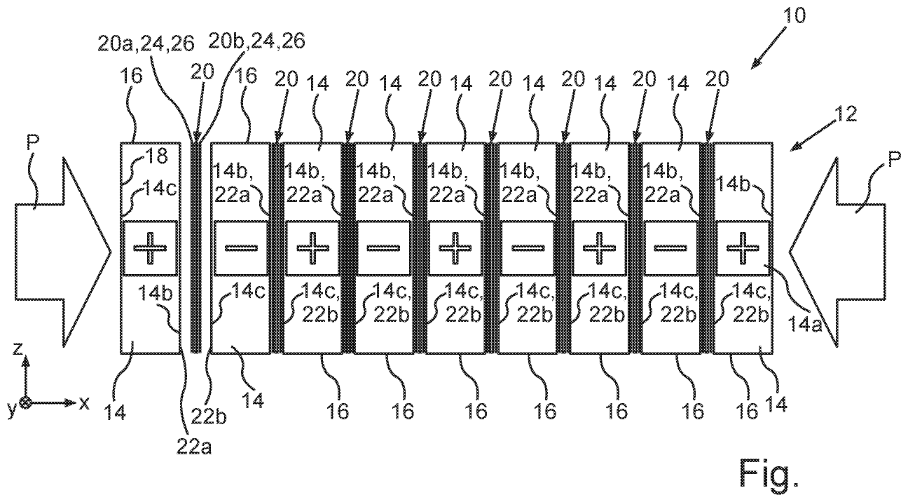

### FIELD

The invention relates to a battery module with a cell stack which has a plurality of battery cells arranged next to one another in a stacking direction, wherein the battery cells comprise a first and second battery cell which are arranged adjacent to one another in the stacking direction. Furthermore, a cell separating element for electrically and thermally insulating the first and second battery cell from one another is arranged at least between the first and second battery cell, wherein the cell separating element lies flat on the first and second battery cell. Furthermore, the invention also relates to a method for producing a battery module.

### BACKGROUND

When constructing cell modules, which are also referred to here as battery modules, individual cells are combined to form a stack, a so-called stack. The cell housings are separated by a so-called cell separating element. This has a number of tasks, such as keeping the cells together in a stable manner, thermally separating cells from one another and also electrically insulating the cells from one another, and so on. Basically, the battery cells should be held together stably so that under loads, for example in the event of a crash with up to 50 g, or 50 times the acceleration due to gravity, their slipping and the resulting cell module or cell stack deformation are prevented. To do this, the cells are usually stacked by starting with a cell, then gluing a cell separating element on one side, then by providing the other side of the cell separating element with an adhesive or by peeling off the protective film of a transfer tape and then gluing on the next cell. A separating element is then glued on top of that, and another cell on top of that, until the entire cell stack is complete. The cell stack is then pressed and checked to see whether it is in order. In particular, it is checked that there is no insulation resistance fault between the individual cells, as this can later lead to dangerous short circuits or a creeping self-discharge to the point of breakdowns and service at the workshop or even reactions within the cell module. This can occur, for example, when contaminants such as particles, chips or the like get between the cells. Such a fault can be detected, but the cell stack cannot then be reworked since the cells are already inseparably glued together. If one now tries to loosen the adhesion, the sensitive cell insulation layer would be damaged and the damage would be even greater. Such a cell stack with, for example, 15 large-volume cells would be worth around 1,000.00 euros, which is a major economic loss due to a small particle and this would also not be a sustainable and environmentally friendly procedure if new, valuable cells had to be disposed of because of such an incident, just because they cannot be reworked.

It would therefore be desirable to facilitate reworking in the event of a detected insulation fault or other fault in a battery module.

WO 2010/031857 A2 describes a cooling unit for an energy storage unit, which has a plurality of flat cells arranged in a stack. The cooling unit comprises at least one base plate which is in thermally conductive connection with the essentially planar cooling elements which are arranged parallel to one another and are spaced apart from one another. The cooling unit also includes a heat exchanger which is associated with the base plate and has a mounting surface which faces the base plate. The cooling elements are in surface contact with the flat cells in order to create good thermal coupling between these components. In order to prevent the flat cells from being pushed laterally out of the cooling modules, closing plates are provided on the side of the cooling unit opposite the base plate.

Additional components in the form of plates are required to hold the cells in position.

### SUMMARY

The object of the present invention is therefore to provide a battery module and a method that allow the provision of a battery module that is as stable as possible in the simplest possible way and also allow rework in the event of a detected defect in the simplest possible way.

The invention relates to a battery module with a cell stack which has a plurality of battery cells arranged next to one another in a stacking direction, wherein the battery cells comprise a first and second battery cell which are arranged adjacent to one another in the stacking direction. Furthermore, a cell separating element for electrically and thermally insulating the first and second battery cell from one another is arranged at least between the first and second battery cell, wherein the cell separating element lies flat on the first and second battery cell. There is a frictional connection between the cell separating element and at least the first battery cell, which connection counteracts a relative movement of the at least one first battery cell and the cell separating element perpendicular to the stacking direction, wherein there is also no material connection between the first battery cell and the cell separating element.

The cell separating element and the first battery cell are therefore not connected to one another by an adhesive connection, a welded connection or any other material connection, but rather by means of a frictional connection, in particular exclusively by means of a frictional connection. This advantageously allows simple rework in the event of a detected defect, since in this case the connection between the cell separating element and the first battery cell can be easily released again. In particular, this connection can be released non-destructively, and the damage when the connection is released is not increased further. The invention is based on the finding that a cell stack, as described above, is braced by means of a tensioning device in order to keep the cell stack within a defined installation space in the stacking direction over the course of its service life, despite expansion of the individual battery cells, which is also referred to as swelling. Consequently, the first and the second battery cell are also pressed very strongly on both sides against the cell separating element or the cell separating element is clamped between the first and second battery cells. This increases the frictional force between the cell separating element and at least the first battery cell, and this also increases over the course of the service life of the battery module, which makes counteracting a relative movement between the first battery cell and the cell separating element perpendicular to the stacking direction all the more efficient. Furthermore, the invention is based on the finding that there are numerous ways to increase the coefficient of friction between the cell separating element and the first battery cell or to provide the highest possible coefficient of friction between these components, such as by high-friction coatings, surface structuring, rubber coatings on the surfaces and so on. These measures require little or no additional installation space and all allow the provision of a stable battery module without the need for additional brackets or retaining plates or the like in order to hold the cells in position in the cell stack. This can advantageously be achieved solely by frictional connection between the cell separating elements and the adjacent battery cells and also enables very simple reworking, since the cell stack can be disassembled again, easily and without damage to the cells or cell separating elements, into its individual components, in particular the cells and the cell separating elements.

In order for the cell separating element to provide electrical and thermal insulation between the two adjacent battery cells, it is preferably formed from an electrically insulating material or has at least one outer layer made from an electrically insulating material. In order to provide the best possible thermal insulation, it is very advantageous to make the cell separating element completely from an electrically insulating material, in particular a plastic material, since plastics are generally very good thermal insulators. But other materials are also possible, such as mica or the like. At least it is preferred that the cell separating element is not formed from a metallic material and in particular does not comprise any such material.

In addition, the battery cells can be designed, for example, as prismatic battery cells or pouch cells, such as lithium-ion cells. In addition, it is preferred that such a cell separating element is provided between each two battery cells arranged adjacent in the stacking direction, which element is used for the electrical and thermal insulation of the two battery cells adjacent to this cell separating element. These additional cell separating elements can also be designed as the presently described cell separating element. The battery cells can also be of identical design, as well as in particular the connection of the battery cells to cell separating elements adjacent to them.

The fact that the cell separating element is also intended to provide good thermal insulation between adjacent cells is based on the fact that such thermal insulation is very advantageous, especially in the event of a thermal runaway of a battery cell, since a thermal propagation of such a thermal runaway of a battery cell to the adjacent battery cell is hindered by the interposed thermal insulation provided by the cell separating element and can thus be significantly delayed or even prevented. A thermal propagation can thus be counteracted particularly efficiently.

In principle, it is conceivable, although not preferred, for a material connection in the form of an adhesive bond to be present between the cell separating element and the second battery cell, which is adjacent to or rests against the cell separating element. It is then also possible to disassemble the battery module, in particular the cell stack, into individual battery units, for example for reworking, wherein these are each provided by an individual battery cell with a cell separating element glued thereon. At least such battery units can be replaced individually, which also significantly minimizes the economic disadvantage in the event of a defect, in particular in contrast to sorting out and destroying an entire battery module.

However, since a battery module provided by frictional connection between battery cells and cell separating elements is just as stable as in the case of adhesive bonding, it is preferable not to provide any adhesive connections at all between cell separating elements and battery cells in the battery module. In a further very advantageous embodiment of the invention a frictional connection is also provided between the cell separating element and the second battery cell, which connection counteracts a relative movement of the at least one first battery cell and the cell separating element perpendicular to the stacking direction, wherein there is no material connection between the second battery cell and the cell separating element. No adhesive connection or welded connection or the like is thus provided also between the cell separating element and the second battery cell. As a result, in the event of repairs or reworking of the battery module, each battery cell can be detached from the respective adjacent cell separating elements and vice versa without being destroyed or damaged.

In a further advantageous embodiment of the invention, the battery module has a tensioning device, by means of which the cell stack is tensioned in the stacking direction, so that the tensioning device exerts a tensioning force on the battery cells in and against the stacking direction, which compresses the cell stack. The tensioning device has the advantage that it can efficiently counteract an expansion of the cell stack due to swelling of the individual battery cells, especially over the course of their service life. In addition, the tensioning device can now advantageously also exert a sufficiently high force on the battery cells in and against the stacking direction, which compresses the cell stack and thus additionally increases the frictional force between the cells and the cell separating elements. In addition, the frictional force between the cells and cell separating elements also increases due to the increasing tensioning force over the course of the service life due to the expansion of the cells. The battery module and the cell stack become even more stable over the course of their service life. The tensioning device can be designed, for example, as a tensioning frame or tensioning band or the like surrounding the battery module. The battery module can have two end plates, for example, which delimit the cell stack on both sides in and against the stacking direction, and which are tensioned together by means of a tensioning device, for example two side plates or a circumferential tensioning band, and are thus pressed onto the cell stack in the direction of the stacking means. This additional tensioning device can delimit the battery module, for example, in and against a second direction perpendicular to the stacking direction, if no further module housing component is then required, for example, in and against a third direction perpendicular to the second direction and perpendicular to the stacking direction. The battery module can be introduced in a complete battery housing, for example, so that an underside of the battery module, which is defined in relation to this third direction, is placed on a housing base of the complete battery housing. The frictional connection between the cell separating elements and the battery cells accordingly prevents a cell or a cell separating element from slipping out of this cell assembly with respect to the third direction on a side opposite the housing base.

In a further advantageous embodiment of the invention, the first battery cell has a first contact surface and the cell separating element has a second contact surface, wherein the first and second contact surfaces rest completely against one another, in particular wherein the first contact surface represents the entire surface of the first battery cell contacting the cell separating element and the second contact surface represents the entire surface of the cell separating element contacting the first battery cell. Such a full-surface contact between the first battery cell and the cell separating element provides a particularly large friction surface. The battery cell, in particular the first one, as well as all the other battery cells, can have a front and a back side, for example, in relation to the stacking direction. These front and back sides can also represent the sides of the battery cells with the largest surface area, for example. It is preferred if a large portion of such a front side, and in particular also of the back side, predominantly or entirely forms the first contact surface, if the battery cell in question does not represent an edge cell of the cell stack, which is a first or last battery cell of the cell stack. The front side, as contact surface, of the first battery cell can thus rest entirely, for example, on the cell separating element. The cell separating element can also have similar or the same dimensions as this front side of the first battery cell. The length of the cell separating element relative to above defined second direction can therefore correspond to a length of the front side of the battery cell and its width relative to the third direction can correspond to a width of the battery cell in this third direction.

In a further advantageous embodiment of the invention, the first and/or second contact surface have a friction-increasing film. The use of a film to provide the highest possible coefficient of friction is very advantageous, since such a film can be applied very flexibly to any desired surface. For example, such a friction-increasing film can be glued to one side of the cell separating element and/or in a corresponding manner to one side of the first battery cell, in particular its front side. Of course, a corresponding film can also be applied to a back side opposite the front side of the first battery cell if another cell separating element is also adjacent to this back side of the battery cell. The cell separating element can also be provided with such a film on both sides. In principle, it is sufficient if only one of the two contact surfaces between the battery cell and the cell separating element is formed with such a friction-increasing film. If both of these contact surfaces are provided with such a film, an even higher coefficient of friction can be provided overall. The application of such a film to one side of the battery cell, which provides the first contact surface, also has the advantage that this friction-increasing film, which is in particular also designed to be electrically insulating, provides the electrical insulation for the first battery cell, and can provide it in a corresponding manner for all remaining battery cells. As described at the outset, battery cells typically have an electrically insulating film in order to electrically insulate the battery cells from the outside. This can now be dispensed with or it can be replaced by the friction-increasing film. As a result, installation space can be saved in the stacking direction in particular, or to put it another way, the installation space required in the stacking direction does not increase due to the friction-increasing film if the normal insulating film is dispensed with instead.

In a further very advantageous embodiment of the invention, the friction-increasing film is designed with a rubber coating, in particular made of natural or artificial rubber, and/or a silicone coating or the like. Rubber coatings or rubber-like coatings, or in general coatings made of elastomers or other at least partially elastic plastic materials, are very well suited to provide the highest possible coefficient of friction. In addition, rubber coatings of this type are also electrically insulating, as a result of which electrical insulation can advantageously also be provided at the same time by the film. Such a coated film can then be applied, for example glued, to the desired contact surface or side of the cell separating element and/or the corresponding battery cell to provide the corresponding contact surface. For example, a rubber coating can provide a typical cell insulation film of a respective battery cell with a very high coefficient of friction.

Instead of applying such a coating to a carrier film and then arranging this film accordingly on the side of the cell separating element and/or of the battery cell, such a coating or rubber coating can also be applied directly to the corresponding side to provide the first and/or second contact surface.

Accordingly, in a further advantageous embodiment of the invention the first and/or second contact surface are formed with a friction-increasing coating, in particular a rubber coating and/or a silicone coating. The coating can therefore be provided, for example, in the form of a rubber coating. In this case, this coating is not initially arranged on a carrier film and then applied to the corresponding contact surface by attaching the carrier film, but it is rather applied directly to the corresponding side that provides the contact surface.

In the case of the battery cell, the usually present insulating film can serve as a carrier film for such a coating.

Above all, it is particularly advantageous if, instead of the first contact surface, the second contact surface is either formed with such a friction-increasing coating or is provided by a film with such a friction-increasing coating. This advantageously makes it possible to retain the currently usual design of battery cells, and only provide the corresponding cell separating elements with films and/or coatings, or even construct them with a solid material having a high coefficient of friction with respect to the cell contact surfaces, as will be described later.

In a further advantageous embodiment of the invention, the frictional connection is provided by a Velcro connection, in particular wherein the first contact surface is formed with a first Velcro connection part and the second contact surface is formed with a second Velcro connection part corresponding to the first Velcro connection part. If thus the frictional connection is to be provided by a Velcro connection, it is preferred that both contact surfaces have a corresponding Velcro connection part. A Velcro connection allows for an extremely high level of friction perpendicular to the stacking direction. For example, one of the two Velcro connection parts can be designed as a hook strip and the other as a fleece strip or felt strip. The respective strips are formed with a surface that corresponds to the respective contact surface. In addition to the combination of hook and loop tape, there are also several other Velcro connection techniques, such as mushroom tape and velor tape, mushroom tape and loop tape, mushroom tape on mushroom tape and extruded hooks or mushrooms on knitted fabric.

Such hook and loop fasteners can also be provided as micro Velcro fasteners. These are very thin and accordingly the installation space required in the stacking direction can be reduced to a minimum.

The previously described options for forming the first contact surface of the first battery cell can also be applied analogously to all contact surfaces of all battery cells of the battery module that are in contact with a corresponding second contact surface of a cell separating element, or can be used in the same way. Accordingly, the design options described for the second contact surface of the cell separating element can also be used and transferred in the same way to the opposite side of the cell separating element, and in particular also for all other optional further cell separating elements and their contact sides or contact surfaces that are in contact with an adjacent battery cell. Edge cells of the cell stack can also be provided with such a friction-increasing film or coating, even if they are not adjacent to a cell separating element but to the end plates described above, in order to correspondingly increase the friction relative to these end plates. This also further increases the stability of the battery module.

In particular, the cell separating elements can not only be provided with a specially designed surface on their contact sides or contact surfaces, but they can also be made of a corresponding solid material, which enables the highest possible coefficient of friction relative to the first contact surface of adjacent battery cells.

A high coefficient of friction should generally be understood to mean a coefficient of friction of at least 0.3, in particular at least 0.4, preferably at least 0.5, particularly preferably at least 0.6.

Accordingly, in a further advantageous embodiment of the invention the cell separating element is formed from a dimensionally stable, electrically insulating, at least partially elastic solid material, in particular from rubber or silicone. Rubber or silicone in particular have very good friction properties and are also very good electrical and, above all, thermal insulators. Due to the partially elastic properties, a particularly uniform distribution of pressure on the cells can be achieved when the battery module is pressed together by above said tensioning device. In addition, this allows the contact area to be maximized, since an elastic material can adapt very well to small, microscopic unevenness.

The options described above for providing a connection with the highest possible coefficient of friction can also be combined with one another in any desired manner.

Furthermore, the invention also relates to a battery, in particular a high-voltage battery having a battery module according to the invention or one of its embodiments. A motor vehicle having a battery module according to the invention or a high-voltage battery according to the invention or one of its embodiments should also be regarded as included in the invention.

Such a high-voltage battery can in particular comprise a plurality of the described battery modules. These can be arranged in a common battery housing. Each battery module can in turn comprise numerous battery cells, wherein a cell separating element is arranged and frictionally fastened as described between two respective battery cells arranged adjacent to one another.

The motor vehicle according to the invention is preferably designed as an automobile, in particular as a passenger car or truck, or as a passenger bus or motorcycle.

The invention also relates to a method for producing a battery module, wherein a cell stack which has a plurality of battery cells arranged next to one another in a stacking direction, is provided, wherein the battery cells comprise a first and second battery cell which are arranged adjacent to one another in the stacking direction. Furthermore, a cell separating element for electrically and thermally insulating the first and second battery cell from one another is arranged at least between the first and second battery cell, whereby the cell separating element lies flat on the first and second battery cell. The cell separating element is arranged in such a way that there is a frictional connection between the cell separating element and at least the first battery cell, which connection counteracts a relative movement between the at least one first battery cell and the cell separating element perpendicular to the stacking direction, wherein there is also no material connection provided between the first battery cell and the cell separating element.

The advantages described in relation to the battery module according to the invention and its embodiments apply in the same way to the method according to the invention.

The invention also includes developments of the method according to the invention, which have the same features which have already been described in conjunction with the developments of the battery module according to the invention. For this reason, the corresponding developments of the method according to the invention are not described again here.

The invention also comprises the combinations of the features of the described embodiments. The invention also includes implementations that each comprise a combination of the features of several of the described embodiments, provided that the embodiments were not described as mutually exclusive.

Exemplary embodiments of the invention are described hereinafter. The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

### BRIEF DESCRIPTION OF THE FIGURE

The single figure shows a schematic representation of a battery module 10 according to an exemplary embodiment of the invention.

### DETAILED DESCRIPTION

The battery module 10 has a cell stack 12 with a plurality of battery cells 14 arranged next to one another in a stacking direction x. For each battery cell 14, only one cell pole 14a is illustratively shown, and for reasons of clarity only one of the cell poles 14a shown is provided with a reference numeral. The other cell pole 14a (not shown) of a respective battery cell 14 can be located, for example, on the opposite side with respect to the x-direction. Alternatively, it can also be arranged on the same side of the presently shown cell pole 14a. Furthermore, each battery cell 14 has an electrically insulating film 16 which surrounds the cell housing 18 of a respective battery cell 14 and correspondingly electrically insulates the battery cell 14 from the outside. A cell separating element 20, as part of the battery module 10 is also arranged between the respective battery cells 14, in particular between each two battery cells 14 arranged adjacently in the x-direction. This serves to electrically and thermally insulate the battery cells 14 adjacent to the corresponding cell separating element 20. In this way, an electrical insulation of the cells 14 from one another can be additionally ensured, and above all a thermal spread of a thermal runaway of one of the battery cells 14.

Usually, such cell separating elements are glued to the adjacent battery cells. In this case, adhesive can be applied directly to the cell separating elements or an adhesive transfer tape can be used, which accomplishes this bonding between cell separating elements and battery cells. In the event of a defect, however, such a bond prevents a non-destructive disassembly of such a battery module and in particular a disassembly of the cell stack into its individual components, namely of the individual cells in cell separating elements.

In the present case, no material connection is provided as a connection between the cell separating elements 20 and the adjacent battery cells 14. In the present case, the connection between the cell separating elements 20 and the respective adjacent battery cells 14 is realized solely on the basis of a frictional connection. For this purpose, each side 20a, 20b of such a cell separating element 20, which at the same time also provides a contact surface 20a, 20b, which rests against corresponding contact surfaces 22a, 22b of the adjacent battery cells 14, is provided with a thin layer with a rubber coating, namely with a rubber coating 24, or can be formed with a film 26 with such a rubber coating or another coating, for example by such a coating 24 or film 26, which has a very high coefficient of friction relative to the cell insulating film 16 of the adjacent battery cells 14, being applied on the relevant sides 20a , 20b of the cell separating element 20.

For reasons of clarity, here too only one respective side 20a, 20b and one coating 24 or film 26 of only one cell separating element is provided with a reference numeral, but the other cell separating elements 20 can also be designed in the same way.

A respective contact surface 20a, 20b of a cell separating element 20 thus represents that surface of the cell separating element 20 which rests against the adjacent cells 14. The corresponding contact surfaces 22a, 22b of the cells 14 preferably extend over a large part or the entire front side 14b or back side 14c of such a battery cell 14 in relation to the x-direction.

Instead of applying such a coating 24 or film 26 to the cell separating elements 20 or forming the cell separating elements 20 with such a coating 24 or film 26, the contact surfaces 22a, 22b of the adjacent cells 14 could also be formed accordingly, or they can also be formed with a such a coating 24 and/or film 26. A part of the insulating film 16 or the entire insulating film 16 can also be replaced with such a film with a rubber coating. The coated film 26 can thus also take over the electrical insulation of the cell 14 to the outside at the same time.

In addition to coatings and films with coatings, other frictional connections are also conceivable, such as Velcro connections. Such a Velcro connection could also be implemented through the respective contact surfaces 20a, 20b, 22a, 22b.

There are thus advantageously numerous possibilities for providing a stable battery module 10 without a material connection between cell separating elements 20 and cells 14, which can be dismantled again into its individual components in a simple and non-destructive manner for repair and maintenance purposes.

If the cell stack 12 is pressed together and fixed in this state, for example by means of a tensioning device or a tie, large forces act on the cells 14 and accordingly also between the cells 14. These forces generated by the tensioning device are illustrated by the arrows P. These forces P in conjunction with the special coating 24 or film 26 ensure that the cells 14 can no longer slip or shift under extreme loads. The constructive properties and also the costs remain approximately the same, but this means that the compressed cell stack 12 can also be disassembled non-destructively at individual cell levels.

This property can be used both for the initial construction, if a measurement should detect a fault from cell 14 to cell 14 or within a cell 14 immediately after pressing, but also later if necessary, when the cell module construction has progressed further or up to the finished cell module 10 in the high-voltage battery, possibly already installed in the vehicle. If a fault in or on a cell 14 becomes known, the entire cell module 10 no longer has to be replaced for a purchase price of 1,000.00 euros or several 1,000.00 euros, but in the best case it can be repaired down to the individual cell level. This is not only easy on the wallet, but also promotes sustainability and reduces production and warranty costs.

Overall, the examples show how a releasable cell separating element for battery modules can be provided by the invention.

1. A battery module having a cell stack, which has multiple battery cells arranged next to one another in a stack direction,
wherein the battery cells comprise a first and a second battery cell which are arranged adjacent to one another in the stacking direction,
wherein a cell separating element for electrically and thermally insulating the first and second battery cell from one another is arranged at least between the first and second battery cell, and
wherein the cell separating element lies flat against the first and second battery cell,
wherein a frictional connection is present between the cell separating element and at least the first battery cell, which connection counteracts a relative movement of the at least one first battery cell and the cell separating element perpendicular to the stacking direction, wherein there is no material connection between the first battery cell and the cell separating element.

2. The battery module of claim 1, wherein the battery module has a tensioning device, by means of which the cell stack is tensioned in the stacking direction, so that the tensioning device exerts a tensioning force on the battery cells in and against the stacking direction, which compresses the cell stack.

3. The battery module of claim 1, wherein a frictional connection is present between the cell separating element and the second battery cell, which connection counteracts a relative movement of the at least one second battery cell and the cell separating element perpendicular to the stacking direction, and wherein there is no material connection between the second battery cell and the cell separating element.

4. The battery module of claim 1, wherein the first battery cell has a first contact surface and the cell separating element has a second contact surface, wherein the first and second contact surfaces rest completely against one another, in particular wherein the first contact surface represents the entire surface of the first battery cell contacting the cell separating element and the second contact surface represents the entire surface of the cell separating element contacting the first battery cell.

5. The battery module of claim 1, wherein the first and/or second contact surface has a friction-increasing film.

6. The battery module of claim 1, wherein the friction-increasing film is designed with a rubber coating, in particular made of natural or artificial rubber, and/or a silicone coating.

7. The battery module of claim 1, wherein the first and/or second contact surface are formed with a friction-increasing coating, in particular a rubber coating and/or a silicone coating.

8. The battery module of claim 1, wherein the frictional connection is provided by a Velcro connection, in particular wherein the first contact surface is formed with a first Velcro connection part and the second contact surface is formed with a second Velcro connection part corresponding to the first Velcro connection part.

9. The battery module of claim 1, wherein the cell separating element is formed from a dimensionally stable, electrically insulating, at least partially elastic solid material, in particular from rubber or silicone.

10. A method for producing a battery module, comprising the steps:
providing a cell stack, which has multiple battery cells arranged next to one another in a stacking direction, wherein the battery cells comprise a first and second battery cell, which are arranged adjacent to one another in the stacking direction;
during the provision of the cell stack, arranging a cell separating element for electrically and thermally insulating the first and second battery cell from one another between the first and second battery cell, whereby the cell separating element lies flat on the first and second battery cell,
wherein the cell separating element is arranged in such a way that there is a frictional connection between the cell separating element and at least the first battery cell which connection counteracts a relative movement between the at least one first battery cell and the cell separating element perpendicular to the stacking direction, wherein there is no material connection provided between the first battery cell and the cell separating element.

11. The battery module of claim 2, wherein a frictional connection is present between the cell separating element and the second battery cell, which connection counteracts a relative movement of the at least one second battery cell and the cell separating element perpendicular to the stacking direction, and wherein there is no material connection between the second battery cell and the cell separating element.

12. The battery module of claim 2, wherein the first battery cell has a first contact surface and the cell separating element has a second contact surface, wherein the first and second contact surfaces rest completely against one another, in particular wherein the first contact surface represents the entire surface of the first battery cell contacting the cell separating element and the second contact surface represents the entire surface of the cell separating element contacting the first battery cell.

13. The battery module of claim 3, wherein the first battery cell has a first contact surface and the cell separating element has a second contact surface, wherein the first and second contact surfaces rest completely against one another, in particular wherein the first contact surface represents the entire surface of the first battery cell contacting the cell separating element and the second contact surface represents the entire surface of the cell separating element contacting the first battery cell.

14. The battery module of claim 2, wherein the first and/or second contact surface has a friction-increasing film.

15. The battery module of claim 3, wherein the first and/or second contact surface a friction-increasing film.

16. The battery module of claim 4, wherein the first and/or second contact surface has a friction-increasing film.

17. The battery module of claim 2, wherein the friction-increasing film is designed with a rubber coating, in particular made of natural or artificial rubber, and/or a silicone coating.

18. The battery module of claim 3, wherein the friction-increasing film is designed with a rubber coating, in particular made of natural or artificial rubber, and/or a silicone coating.

19. The battery module of claim 4, wherein the friction-increasing film is designed with a rubber coating, in particular made of natural or artificial rubber, and/or a silicone coating. The battery module of claim 5, wherein the friction-increasing film is designed with a rubber coating, in particular made of natural or artificial rubber, and/or a silicone coating.
